(19) United States
(12) Patent Application Publication
(10) Pub. No.: US 2010/0328666 A1
(43) Pub. Date: Dec. 30, 2010

(54) POLARIZATION-INDEPENDENT UP-CONVERSION PHOTON DETECTION APPARATUS

(75) Inventors: Tae-Gon Noh, Daejeon (KR); Seok-Beom Cho, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 12/918,272

(22) PCT Filed: Jul. 4, 2008
(86) PCT No.: PCT/KR2008/003968

§ 371 Date: Aug. 18, 2010

(30) Foreign Application Priority Data
Mar. 5, 2008 (KR) 10-2008-0020656

(51) Int. Cl. G01J 4/00

(52) U.S. Cl. 356/365

(57) ABSTRACT

A photon detection apparatus includes an optical divider splitting incident signal light by polarization components, an optical mixer mixing pump light with the signal light output from the optical divider, an up-converter up-converting a frequency of the mixed signal light including the pump light, and an optical detector detecting the up-converted signal light.

### TECHNICAL FIELD

The present invention relates to photon detection apparatuses. More particularly, the present invention disclosed herein is concerned with a photon detection apparatus with frequency up-conversion.

### BACKGROUND ART

In the field of information technology based on optical fibers, such as quantum cryptography communication, it is increasing the importance of technology detecting photons of telecom bands such as 1.5 mm through 1.3 mm. Photons of telecom bands can be detected by avalanche photodiodes (APDs) of InGaAs type. As InGaAs-APDs have low quantum efficiency and high generation probability of after-pulses, it is usually required to operate them discontinuously in a gated mode under 10 MHz.

For the purpose of overcoming those technical difficulties in such InGaAs-APDs, it has been proposed to use silicon-based APDs (hereinafter, referred to as ‘Si-APDs’) that can be operated in high quantum efficiency and continuous mode. However, as the Si-APDs are only able to detect photons with very high quantum efficiency in visible light band, using the Si-APDS should be preceded by conducting a process of up-converting photons of the telecom bands into photons of the visible light bands (0.4˜0.7 μm). Such up-conversion can be accomplished through sum-frequency generation using an optical nonlinear medium such as a periodically poled lithium-niobate (PPLN). But, since the up-conversion with PPLN may be affected from polarization of incident light, there is a problem of fluctuating efficiency of light detection depending on a polarization state of incident light.

To overcome such dependence on polarization, several methods have been proposed independently by M. A. Albota and H. Takesue. In detail, M. A. Albota proposed a scheme of bidirectional up-conversion (refer to Journal of the Optical Society of America B, 2006, entitled “Polarization-independent frequency conversion for quantum optical communication”, M. A. Albota et al.), while H. Takesue proposed a technique using a polarization beam splitter (refer to Optical Express, 2006, entitled “1.5-mm single photon counting using polarization-independent up-conversion detector”, H. Takesue et al.). However, according to those technologies, an up-conversion system may be complicated in architecture.

For example, the bidirectional conversion system by M. A. Albota is difficult in optical arrangement and needs many optical parts for wave separation and polarization conversion in an interferometer. Thus, in addition to systemic complexity, there is a drawback of high transmission loss. Meanwhile, the Takesue's system is regarded as having a disadvantage of systemic complexity and high cost because it is needed to have two members of up-conversion detectors.

### DISCLOSURE OF INVENTION

### Technical Problem

Accordingly, the present invention is directed to a polarization-independent up-conversion photon detection apparatus with simplicity and high efficiency.

### Technical Solution

An aspect of the present invention is a photon detection apparatus including an optical divider splitting incident signal light by polarization components, an optical mixer mixing pump light with the signal light output from the optical divider, an up-converter up-converting a frequency of the mixed signal light including the pump light, and an optical detector detecting the up-converted signal light.

The optical divider includes: a polarization beam splitter dividing the signal light to propagate along first and second paths, which are different from each other, depending on the polarization components; and a polarization controller making signal light, which propagates along the second path, same as signal light, which propagates along the first path, in polarization state. The polarization controller is a half-wave plate. The optical divider further comprises at least one of first and second optical delay elements disposed each on the first and second paths. Here, the first and second optical delay elements are configured to adjust lengths of the first and second paths.

The optical mixer is configured to make the pump light propagate along the same path with the signal light. The pump light is incident on the optical mixer in a polarization state to raise sum-frequency up-conversion efficiency.

The up-converter is formed of one from nonlinear optical materials. For example, the nonlinear optical materials include a periodically poled lithium-niobate waveguide and a periodically poled titanyl phosphate waveguide.

The optical detector includes a filter selectively abstracting the up-converted signal light, and a photon detector detecting the up-converted signal light. The photon detector is one of a Si-based photodetector, a Si-based single photodetector, and a Si-based photon-number resolving detector.

Meanwhile, the optical mixer, the up-converter, and the optical detector are commonly used in detecting a plurality of the signal light that are split by the optical divider and propagate along paths different to each other.

Another aspect of the present invention is a polarization-independent up-conversion photon detection apparatus comprised of an optical divider splitting signal light to propagate along paths different from each other and then converting a polarization state, which propagates along one of the paths, into another polarization state propagating along another path. Here, the optical divider converts the polarization state of the signal light so as to maximize sum-frequency conversion efficiency of the signal light and pump light regardless of the path of the signal light.

The polarization-independent up-conversion photon detection apparatus may be further comprised of an optical mixer mixing the pump light with the signal light output from the optical divider, an up-converter up-converting a frequency of the mixed signal light including the pump light, and an optical detector detecting the up-converted signal light. The optical mixer, the up-converter, and the optical detector are commonly used in detecting a plurality of the signal light that are split by the optical divider and propagate along the paths different to each other.

A further understanding of the nature and advantages of the present invention herein may be realized by reference to the remaining portions of the specification and the attached drawings.

### ADVANTAGEOUS EFFECTS

According to the present invention, a polarization-independent up-conversion photon detection apparatus is provided with including a single light divider, a single light mixer, a single up-converter, and a single light detector, capable of accomplishing frequency up-conversion without polarization dependence. Accordingly, the photon detection apparatus is advantageous to production cost because of its structural simplicity, as well as enhancing the efficiency in detecting photons regardless of a polarization state of signal light (or incident light).

### BRIEF DESCRIPTION OF THE DRAWINGS

FIG. 1 is a block diagram of a polarization-independent up-conversion photon detection apparatus according to the present invention.

FIG. 2 is a diagram concretely illustrating the polarization-independent up-conversion photon detection apparatus in accordance with an embodiment of the present invention.

FIG. 3 is a diagram concretely illustrating the polarization-independent up-conversion photon detection apparatus in accordance with a modified embodiment of the present invention.

### BEST MODE FOR CARRYING OUT THE INVENTION

Hereinafter, preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

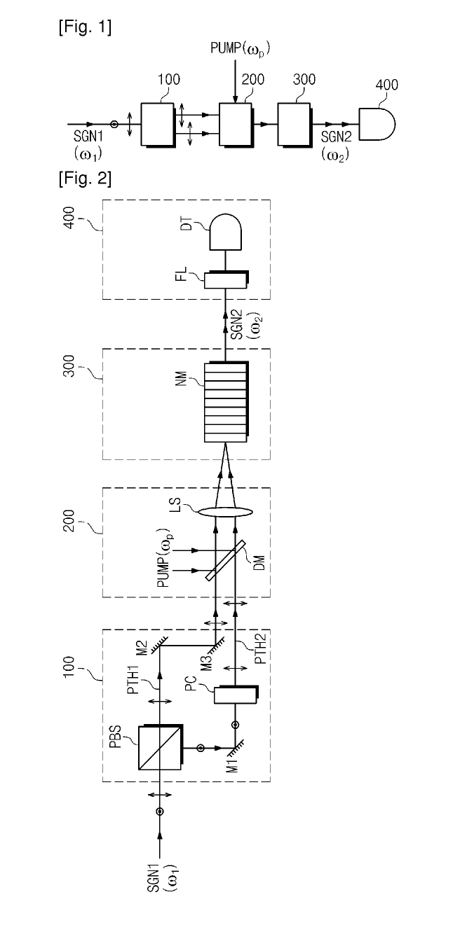

FIG. 1 is a block diagram of a polarization-independent up-conversion photon detection apparatus according to the present invention.

Referring to FIG. 1, the photon detection apparatus according to the present invention is configured to accomplish frequency up-conversion without dependence on polarization, including an optical divider 100, an optical mixer 200, an up-converter 300, and an optical detector 400.

The optical divider 100 transforms signal light SGN1 (ω₁) to be in a polarization state (hereinafter, referred to as ‘first polarization state’) that is able to maximize sum-frequency conversion efficiency in the up-converter 300. For this operation, the optical divider 100 is configured to divide incident signal light into a first polarization state and a second polarization state that is vertical to the first polarization state, and then to convert the second polarization state into the first polarization state. The optical divider 100 may be comprised of a polarization beam splitter, a half-wave plate, at least an optical delay line, pluralities of mirrors, at least one of an optical fiber and a waveguide.

The optical mixer 200 is configured to mix pump light PUMP (ωₚ) of the first polarization state with signal light output from the optical divider 100. According to the present invention, as signal light incident on the optical mixer 200 is adjusted to have the first polarization state, as aforementioned, by the optical divider 100, the signal light SGN1 and the pump light PUMP incident on the optical mixer 200 are all conditioned in a state (i.e., the first polarization state) capable of maximizing the sum-frequency conversion efficiency in the up-converter 300.

The up-converter 300 includes nonlinear optical materials enabling frequency up-conversion through interaction between the signal light SGN1 and the pump light PUMP. According to this, representing the frequencies of the signal light SGN1 and the pump light PUMP by ω₁ and ωₚ respectively, photons output from the up-converter 300 has an up-converted frequency ω₂ of ω₁+ωₚ by way of sum frequency generation (SFG).

The optical detector 400 is configured to selectively detect the up-converted signal light SGN2 (ω₂) output from the up-converter 300. For this selective detection, the optical detector 400 is comprised of a filter FL blocking optical components with frequencies different from the frequency ω₂ of the up-converted signal light SGN2, and a photon detector DT sensing photons of the up-converted frequency passing through the filter FL.

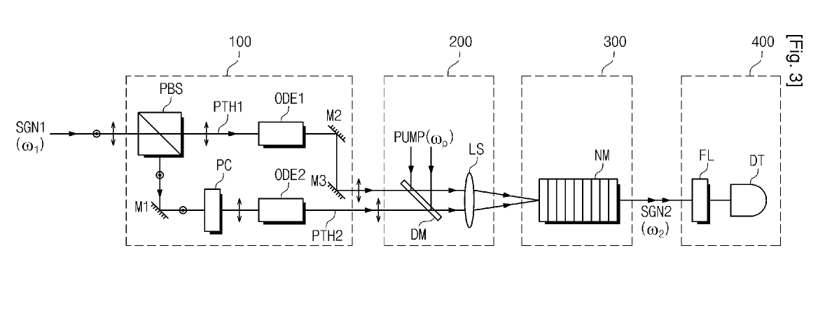

FIG. 2 is a diagram concretely illustrating the polarization-independent up-conversion photon detection apparatus in accordance with an embodiment of the present invention. This embodiment is more detailed than that shown in FIG. 3. Therefore, for convenience of description, hereinafter will be neglected the duplicates about the technical features as same as the aforementioned in conjunction with FIG. 1.

With reference to FIG. 2, according to this embodiment, the optical divider 100 includes the polarization beam splitter PBS for dividing the incident signal light SGN1 according thereto. Thus, the signal light SGN1 incident upon the polarization beam splitter PBS can be divided into a component propagating along a first path PTH1 with the first polarization state ( [symbol] ), and a component propagating along a second path PTH2 with a polarization state (i.e., the second polarization state (\textcircled{.})) vertical to the component propagating along the first path PTH1. As aforementioned, the first polarization state ( [symbol] ) is preferred to be one capable of maximizing the sum-frequency conversion efficiency in the up-converter 300. Otherwise, according to another embodiment of the present invention, the second polarization state may be out of being vertical to the first polarization state, basically different from the first polarization state in direction.

In the meantime, as aforementioned, considering that the first polarization state ( [symbol] ) is selected to maximize the sum-frequency conversion efficiency, the photon detection efficiency may be degraded if the signal light SGN1 is conditioned in the second polarization state (\textcircled{.}). To prevent such degradation of the photon detection efficiency, the optical divider 100 may be further comprised of a polarization controller PC for converting the second polarization state into the first polarization state on the second path PTH2. For instance, the polarization controller PC may be male up with a half-wave plate, but it is not restrictive hereto. The polarization controller PC may be one of various optical devices capable of converting the second polarization state into the first polarization state.

According to this embodiment, the photon detection apparatus may comprise one optical divider 100, one optical mixer 200, one up-converter 300, and one optical detector 400. In this case, regardless of the propagation paths PTH1 and PTH2 in the optical divider 100, it is required of making the signal light SGN1 incident on the optical mixer 200 in common. For this, the optical divider 100 may be comprised of a path controller PC for controlling the first and second paths PTH1 and PTH2. Exemplarily, as shown in FIG. 2, the path controller may be male up by minors M1, M2, and M3, or although not shown, a waveguide such an optical fiber.

As a result, the signal light SGN1 incident on the optical mixer 200 from the optical divider 100 is controlled to have the same polarization state and the same propagation direction regardless of its traveling path.

By another embodiment of the present invention, as illustrated in FIG. 3, the polarization-independent up-conversion photon detection apparatus may be comprised of first and second optical delay elements ODE1 and ODE2 respectively on the first and second paths PTH1 and PTH2. The first and second optical delay elements ODE1 and DOE2 are configured to adjust a lengthwise gap between the first and second paths PTH1 and PTH2.

According to this embodiment, lengths of the first and second paths PTH1 and PTH2 can be adjusted by means of the first and second optical delay elements ODE1 and ODE2. But, according to another embodiment, the first and second paths PTH1 and PTH2 may be set to be different from each other in correspondence with application and operation scheme of the photon detection apparatus. For instance, if there is a need to find which polarization state is involved in the incidence on the optical divider 100 for photons sensed by the optical detector 400, the first and second optical delay elements ODE1 and ODE2 may be adjusted to make a path length difference between PTH1 and PTH2. In this case, the initial polarization state of the signal light SGN1 is found by way of monitoring a difference of photon detection times resulting from such a lengthwise gap between the first and second paths PTH1 and PTH2.

On the other hand, it may be readily seen that the lengthwise adjustment of the optical paths can be also accomplished by the single optical delay element. According to a modification of the present invention, it is available to arrange an alternative one of the first and second optical delay elements ODE1 and ODE2.

Returning to FIG. 2, the optical mixer 200, for mixing the signal light SGN1 with the pump light PUMP, is comprised of a dichroic mirror DM that transmits the signal light SGN1 output from the optical divider 100 and reflects the pump light PUMP thereon. Thus, as shown therein, the pump light PUMP and the signal light SGN1 are able to propagate in parallel toward the up-converter 300. In addition, as aforementioned, the pump light PUMP can be incident on the optical mixer 200 in the same polarization state with the signal light SGN1. In this case, the signal light SGN1 and the pump light PUMP are all conditioned in the polarization state (i.e., the first polarization state) that is capable of maximizing the sum-frequency conversion efficiency in the up-converter 300.

Meantime, according to the present invention, the optical mixer 200 may be further comprised of a lens LS to focus light, which propagates toward the up-converter 300 from the dichroic mirror DM, so as to shrink down the up-converter 300 in size, as shown in FIG. 2.

The function of the optical mixer 200, mixing the signal light SGN1 with the pump light PUMP and making the mixed light incident on the up-converter 300, can be accomplished by means of other optical devices. Therefore, the optical mixer 200 according to the present invention may not be restrictive to the dichroic minor DM or the lens LS, but it is permissible to implement the optical mixer 200 in various forms well known by those skilled in the art.

The up-converter 300 may be formed of a periodically poled lithium-niobate (PPLN) waveguide or periodically poled potassium-titanyl-phosphate (PPKTP) waveguide.

The present invention is also applicable to a process for up-converting photons of various telecom bands. In this case, a wavelength of the incident light (i.e., the signal light) can be variously selected without predetermination. For instance, materials exemplified by the following table may be used for up-converting light of various telecom bands. But, it is easily known for those artisans skilled in the art to understand that there are other available materials for the up-converter 300 according to the present invention.

TABLE 1
Optically nonlinear materials

Lithium iodate (LiIO₃), Potassium niobate (KNbO₃), Monopotassium
phospate (KH₂PO₄, KDP), Lithium triborate (LBO), β-barium borate
(BBO), Gallium selenide (GaSe), Potassium titanyl phosphate (KTP),
Lithium niobate (LiNbO₃), Ammonium dihydrogen phosphate (ADP)

The optical detector 400 may be comprised of the filter FL and the photon detector DT. The filter FL makes the up-converted light or photons SGN2 incident on the photon detector DT by blocking optical components different from its own frequency ω₂. For this blocking, the filter FL may be comprised of a prism for differentiating propagation paths with photons depending on wavelengths, further including a dichroic minor or a short-wavelength transmission filter. The photon detector DT may be one of a Si-based photodetector, a Si-based single-photon detector, and a Si-based photon-number resolving detector. It is possible to select types of the filter FL and photon detector DT in various forms corresponding to applicational and operational features of the photon detection apparatus by the present invention.

The above-disclosed subject matter is to be considered illustrative, and not restrictive, and the appended claims are intended to cover all such modifications, enhancements, and other embodiments, which fall within the true spirit and scope of the present invention. As an example, a light propagation path of the polarization-independent up-conversion photon detection apparatus may be defined by a waveguide, not by a free space. In this case, at least one of the optical divider 100, the optical mixer 200, the up-converter 300, and the optical detector 400 may be integrated on a substrate.

### INDUSTRIAL APPLICABILITY

The present invention disclosed herein is applicable to detection of photons in the field of information technology based on optical fibers.

1. A photon detection apparatus comprising:
an optical divider splitting incident signal light by polarization components;
an optical mixer mixing a pump light with the signal light output from the optical divider;
an up-converter up-converting a frequency of the mixed signal light including the pump light; and
an optical detector detecting the up-converted signal light.

2. The photon detection apparatus as set forth in claim 1, wherein the optical divider comprises:
a polarization beam splitter dividing the signal light to propagate along first and second paths, which are different from each other, depending on the polarization components; and
a polarization controller making signal light, which propagates along the second path, same as signal light, which propagates along the first path, in polarization state.

3. The photon detection apparatus as set forth in claim 2, wherein the polarization controller is a half-wave plate.

4. The photon detection apparatus as set forth in claim 2, wherein the optical divider further comprises at least one of first and second optical delay elements disposed each on the first and second paths,
wherein the first and second optical delay elements are configured to adjust lengths of the first and second paths.

5. The photon detection apparatus as set forth in claim 1, wherein the optical mixer is configured to make the pump light propagate along the same path with the signal light,
wherein the pump light is incident on the optical mixer in a polarization state to raise sum-frequency up-conversion efficiency.

6. The photon detection apparatus as set forth in claim 1, wherein the up-converter is formed of one from nonlinear optical materials.

7. The photon detection apparatus as set forth in claim 6, wherein the nonlinear optical materials include a periodically poled lithium-niobate waveguide and a periodically poled titanyl phosphate waveguide.

8. The photon detection apparatus as set forth in claim 1, wherein the optical detector comprises:
a filter selectively abstracting the up-converted signal light; and
a photon detector detecting the up-converted signal light.

9. The photon detection apparatus as set forth in claim 8, wherein the photon detector is one of a Si-based photodetector, a Si-based single-photon detector, and a Si-based photon-number resolving detector.

10. The photon detection apparatus as set forth in claim 1, wherein the optical mixer, the up-converter, and the optical detector are commonly used in detecting a plurality of the signal light that are split by the optical divider and propagate along paths different to each other.

11. A polarization-independent up-conversion photon detection apparatus comprising: an optical divider splitting a signal light into two beams propagating along different paths depending on the polarization component of the signal light and then converting a polarization state of one beam into that of another beam.

12. The polarization-independent up-conversion photon detection apparatus as set forth in claim 11, wherein the optical divider converts the polarization state of the beams so as to maximize sum-frequency conversion efficiency of the signal light and pump light regardless of the path of the signal light.

13. The polarization-independent up-conversion photon detection apparatus as set forth in claim 12, further comprising:
an optical mixer mixing the pump light with the signal light output from the optical divider;
an up-converter up-converting a frequency of the mixed signal light including the pump light; and
an optical detector detecting the up-converted signal light,
wherein the optical mixer, the up-converter, and the optical detector are commonly used in detecting a plurality of the signal light that are split by the optical divider and propagate along the paths different to each other.
